(19) United States
(12) Patent Application Publication
(10) Pub. No.: US 2025/0242804 A1
(43) Pub. Date: Jul. 31, 2025

(54) DEVIATION SUPPRESSION CONTROL APPARATUS, DEVIATION SUPPRESSION CONTROL METHOD, AND NON-TRANSITORY COMPUTER-READABLE STORAGE MEDIUM

(71) Applicant: TOYOTA JIDOSHA KABUSHIKI KAISHA, Toyota-shi (JP)

(72) Inventor: Hiroki MURATA, Anjo-shi (JP)

(73) Assignee: TOYOTA JIDOSHA KABUSHIKI KAISHA, Toyota-shi (JP)

(21) Appl. No.: 18/965,482

(22) Filed: Dec. 2, 2024

(30) Foreign Application Priority Data
Jan. 30, 2024 (JP) 2024-011623

(51) Int. Cl. B60W 30/10; B60W 50/00

(52) U.S. Cl. CPC B60W 30/10; B60W 50/0097; B60W 2554/00; B60W 2710/20; B60W 2720/12

(57) ABSTRACT

A deviation suppression control apparatus executes a deviation suppression control for controlling a lateral travel state of a vehicle to suppress the vehicle from deviating from a travel area when a deviation condition is satisfied. The deviation condition is satisfied when the vehicle is predicted to deviate from the travel area or when the vehicle has deviated from the travel area. When a suppression condition including a first condition is satisfied, the deviation suppression control apparatus decreases a magnitude of a lateral speed of the vehicle in the deviation suppression control compared to when the suppression condition is not satisfied. The first condition is satisfied when there is an object in an opposite area opposite to a deviation side where the vehicle deviates from the travel area.

### TECHNICAL FIELD

The present disclosure relates to a vehicle deviation control apparatus configured to execute a deviation suppression control for controlling a lateral travel state of a vehicle to suppress the vehicle from deviating from a travel area when a deviation condition is satisfied, the deviation condition being a condition that is satisfied when the vehicle is predicted to deviate from the travel area or when the vehicle has deviated from the travel area is satisfied, a deviation suppression method for a computer installed on the vehicle to execute the deviation suppression control, and a non-transitory computer-readable storage medium storing a program for causing a computer to execute the deviation suppression control.

### BACKGROUND

Conventionally, there has been known a deviation suppression control apparatus for executing the deviation suppression control when the deviation condition is satisfied. For example, the deviation suppression control apparatus (hereinafter, referred to as a “conventional apparatus”) executes the deviation suppression control in a first operation mode when an approaching speed is low, and executes the deviation suppression control in a second operation mode when the approaching speed is high. The approaching speed represents a speed (a lateral speed) at which the vehicle approaches a boundary of a travel area (for example, a lane).

The vehicle does not decelerate in the first operation mode, and the vehicle decelerates in the second operation mode. In both the first operation mode and the second operation mode, a steering motor is controlled such that the vehicle heads for the center of the travel area.
Patent Document 1: Japanese Patent Application Laid-Open No. 2017-197020

### SUMMARY

In the deviation suppression control, a travel direction of the vehicle is changed from a deviation direction to a return direction. The deviation direction is a direction in which the vehicle deviates from the travel area. The return direction is a direction in which the vehicle returns to the travel area. In a case where there is an object in an area opposite to the deviation direction, the vehicle travels towards the object when the travel direction of the vehicle is changed to the return direction. In this case, a driver may feel anxiety. The conventional apparatus does not take into account the object that is present in the area opposite to the deviation direction of the vehicle. For this reason, the driver may feel the anxiety.

The present disclosure is made to address the above problem. That is, one of objects of the present disclosure is to provide a deviation suppression control apparatus that can reduce a possibility that the driver feels the anxiety, even if the deviation suppression control is executed when there is the object in the area opposite to the deviation direction of the vehicle.

A deviation suppression control apparatus (hereinafter, referred to as “the present disclosure apparatus”) according to the present disclosure is configured to execute a deviation suppression control for controlling a lateral travel state of a vehicle to suppress the vehicle from deviating from a travel area (step 500 to step 595) when a deviation condition is satisfied (“Yes” at step 310). The deviation condition is satisfied when the vehicle is predicted to deviate from the travel area or when the vehicle has deviated from the travel area.

The deviation suppression control apparatus is configured to when a suppression condition including a first condition is satisfied (“Yes” at step 405), decrease a magnitude of a lateral speed of the vehicle in the deviation suppression control (step 430) compared to when the suppression condition is not satisfied (“No” at step 405). The first condition being a condition that is satisfied when there is an object in an opposite area opposite to a deviation side where the vehicle deviates from the travel area.

According to the present disclosure apparatus, the suppression condition is satisfied when there is the object in the opposite area opposite to the deviation side. When the suppression condition is satisfied, the magnitude of the lateral speed of the vehicle in the deviation suppression control is smaller than when the suppression condition is not satisfied. Therefore, a speed at which the vehicle approaches the object decreases so that the possibility that the driver feels anxiety can be reduced.

In some embodiments,
the deviation suppression control apparatus is configured to:
end the deviation suppression control (step 330) when the vehicle reaches a target return position set inside a boundary that defines the travel area (“Yes” at step 325); and
determine that the suppression condition is satisfied when the first condition and a second condition are satisfied, the second condition being a condition that is satisfied in a case where it is predicted that there is the object within a predetermined range of the vehicle when the vehicle reaches the target return position on an assumption that the suppression condition is not satisfied (step 415).

Even if there is the object that satisfies the first condition, when the second condition is not satisfied (in other words, in a case where there is no object within the predetermined range of the vehicle when the vehicle reaches the return target position), a possibility that the vehicle contacts with the object is low. In this case (when the second condition is not satisfied), the possibility that the driver feels the anxiety about the deviation suppression control is low. When the magnitude of the lateral speed in the deviation suppression control is small, even though the possibility that the driver feels the anxiety about the deviation suppression control is low, a possibility that the driver feels annoyed by the deviation suppression control is high. Therefore, in this embodiment, the suppression condition is not satisfied when the second condition is not satisfied.

In some embodiments,
the deviation suppression control apparatus is configured to, when the suppression condition is satisfied, decrease the magnitude of the lateral speed during a time (T2) that it takes for the vehicle to reach a target return position (RP) set inside a boundary that defines the travel area from a change position (CP). The change position is a position at which a travel direction of the vehicle is changed from a deviation direction in which the vehicle deviates from the travel area to a return direction in which the vehicle returns to the travel area in the deviation suppression control.

The driver is likely to feel the anxiety when the vehicle travels towards the object that satisfies the first condition. The vehicle travels in the deviation direction immediately after the deviation suppression control is started, and the vehicle travels in the return direction (in other words, the vehicle travels towards the object) after the vehicle reaches the change point. The deviation suppression control apparatus according to this embodiments decreases “the magnitude of the lateral speed during the time which it takes for the vehicle to reach the target return position from the change point” so as to reduce the possibility that the driver feels the anxiety about the deviation suppression control. It should be noted that the deviation suppression control apparatus does not decrease the lateral speed during a time which it takes for the vehicle to reach the change point from a position of the vehicle when the deviation condition is satisfied. Because it is highly likely that the lateral speed during this time does not affect the driver's anxiety, and if this time is increased, a time during which the vehicle is deviating from the travel area is increased.

In some embodiments,
the deviation suppression control apparatus is configured to determine that the suppression condition is satisfied when the first condition is satisfied and a third condition or a fourth condition is satisfied (“Yes” at step 420). The third condition is satisfied when a subtraction value acquired by subtracting a vehicle width of the vehicle from a width of the travel area is equal to or smaller than a predetermined first threshold value. The fourth condition is satisfied when a ratio of the vehicle width to the width of the travel area is equal to or greater than a predetermined second threshold value.

If neither of the third condition nor fourth condition are satisfied, the width of the travel area is relatively wide compared to the vehicle width. Even if the vehicle approaches the object that satisfies the first condition at the same lateral speed as when the suppression condition is not satisfied, the possibility the driver feels anxiety is low. In such case, when the magnitude of the lateral speed of the vehicle in deviation suppression control is small, the possibility that the driver feels uncomfortable is high. Therefore, the suppression condition is satisfied when the third condition or the fourth condition is satisfied.

In some embodiments,
the deviation suppression control apparatus is configured to decrease the magnitude of the lateral speed, as an object distance decreases. The object distance is a distance between the object and an opposite boundary. The opposite boundary is a boundary on an opposite side of a boundary from which the vehicle deviates between a left boundary and a right boundary that define the travel area.

As the object distance decreases, the vehicle approaches the object more closely. The object shorter the distance, the greater the driver's anxiety. According to the embodiment, the magnitude of the lateral speed of the vehicle VA decreases in accordance with the object distance. Therefore, the possibility that the driver feels the anxiety about the deviation suppression control can be reduced.

A deviation suppression control method according to an embodiment of the present disclosure is a method to execute a deviation suppression control for controlling a lateral travel state of a vehicle to suppress the vehicle from deviating from a travel area (step 500 to step 595) when a deviation condition is satisfied (“Yes” at step 310). The deviation condition is satisfied when the vehicle is predicted to deviate from the travel area or when the vehicle has deviated from the travel area. The deviation suppression control is executed by a computer installed on the vehicle.

The deviation suppression control method comprises:
a first step of determining whether or not a suppression condition including a first condition is satisfied (step 405), the first condition being a condition that is satisfied when there is an object in an opposite area opposite to a side where the vehicle deviates from the travel area; and
a second step of decreasing a magnitude of a lateral speed of the vehicle in the deviation suppression control (step 430) compared to when suppression condition is not satisfied (“No” at step 405), when the suppression condition is satisfied (“Yes” at step 405).

A non-transitory computer-readable storage medium according to an embodiment of the present disclosure stores a program for causing a computer installed on a vehicle to execute a deviation suppression control for controlling a lateral travel state of the vehicle to suppress the vehicle from deviating from a travel area (step 500 to step 595) when a deviation condition is satisfied (“Yes” at step 310). The deviation condition is satisfied when the vehicle is predicted to deviate from the travel area or when the vehicle has deviated from the travel area.

The program causes the computer to implement processes of:
determining whether or not a suppression condition including a first condition is satisfied, the first condition being a condition that is satisfied when there is an object in an opposite area opposite to a side where the vehicle deviates from the travel area (step 405); and
decreasing a magnitude of a lateral speed of the vehicle in the deviation suppression control (step 430) compared to when suppression condition is not satisfied (“No” at step 405), when the suppression condition is satisfied (“Yes” at step 405).

According to the deviation suppression method and the non-transitory computer-readable storage medium according to the embodiment of the present disclosure, the speed at which the vehicle approaches the object decreases so that the possibility that the driver feels anxiety can be reduced.

In the above description, for easier understanding of the present disclosure, the terms and/or reference symbols used in at least one embodiment described below are enclosed in parentheses and assigned to the components of the present disclosure corresponding to the at least one embodiment. However, the constituent elements of the present disclosure are not limited to the at least one embodiment defined by the terms and/or reference symbols. Other objects, other features, and accompanying advantages of the present disclosure are easily understandable from the description of the at least one embodiment of the present disclosure to be given with reference to the following drawings.

### BRIEF DESCRIPTION OF THE DRAWINGS

FIG. 1 is a schematic system configuration diagram of a deviation suppression control apparatus according to an embodiment of the present disclosure.

FIG. 2 is a diagram for explaining an operation example of the deviation suppression control apparatus according to the embodiment of the present disclosure.

FIG. 3 is a flowchart illustrating a start and end determination routine executed by a CPU of an ECU shown in FIG. 1.

FIG. 4 is a flowchart illustrating a suppression condition determination subroutine executed by the CPU of the ECU shown in FIG. 1.

FIG. 5 is a flowchart illustrating a deviation suppression control routine executed by the CPU of the ECU shown in FIG. 1.

### DETAILED DESCRIPTION

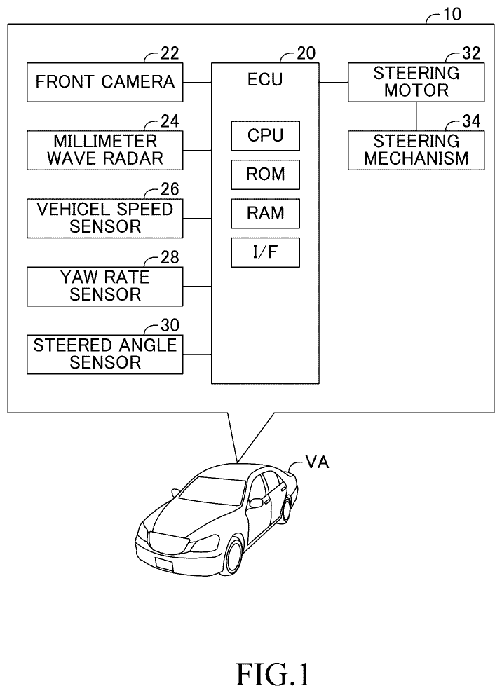

As shown in FIG. 1, a deviation suppression control apparatus 10 (hereinafter, referred to as the “present apparatus 10”) is applied to a vehicle VA and comprises components shown in FIG. 1.

A deviation suppression control ECU 20 is an ECU for executing a deviation suppression control described below, which is a type of automatic driving. Hereinafter, the deviation suppression control ECU 20 is referred to as an “ECU 20”.

In this specification, the “ECU 20” is an electronic control unit with a microcomputer as a main part. The ECU 20 is also referred to as a control unit, a controller and a computer. The microcomputer includes a CPU (processor), a ROM, a RAM, and an interface (I/F), etc. Functions realized by the ECU 20 may be realized by multiple ECUs.

A front camera 22 acquires image data by capturing a scenery in front of the vehicle VA. The front camera 22 transmits the image data to the ECU 20.

The millimeter wave radar 24 transmits a millimeter wave in front of the vehicle VA. The transmitted millimeter wave is reflected by a reflection point of an object. The millimeter wave radar 24 acquires radar object data by receiving a reflected wave reflected by the reflection point. The radar object data includes “a position of the object relative to the vehicle VA” and “a relative speed Vr of the object relative to the vehicle VA”. The millimeter wave radar 24 transmits the radar object data to the ECU 20.

A vehicle speed sensor 26 detects a vehicle speed Vs representing a speed of the vehicle VA. A yaw rate sensor 28 detects a yaw rate Yr applied to the vehicle VA. A steered angle sensor 30 detects a steered angle θ of steered wheels of the vehicle VA. The ECU 20 acquires these detected values.

A steering motor 32 is incorporated in a steering mechanism 34. The steering mechanism 34 is a mechanism for turning the steered wheels in response to an operation of a steering wheel. The steering motor 32 generates an assist torque for assisting the operation of the steering wheel in response to an instruction from the ECU 20, and generates an automatic steering torque to change the steered angle θ of the steered wheels.

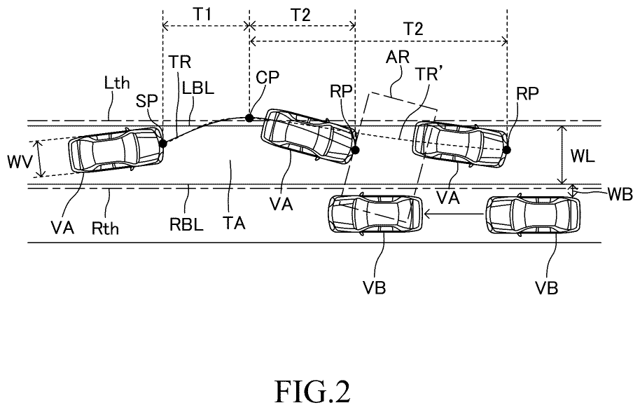

Hereinafter, a deviation suppression control is explained with reference to FIG. 2.

The ECU 20 recognizes boundaries BL (a right boundary RBL and a left boundary LBL) that define (delimit) a driving area TA in which the vehicle VA is traveling, based on the image data. Examples of boundary BL include white lines on a road, guardrails, curbs and walls. The ECU20 sets a reference line at a position that is a predetermined distance from each of the boundaries BL in a direction that is orthogonal to each of the boundaries BL. The ECU 20 sets a right reference line RBL for the right boundary RBL, and a left reference line LBL for the left boundary LBL.

When one of the following conditions 1 and 2 is satisfied, the ECU20 determines that a deviation condition is satisfied so as to execute the deviation suppression control.

Condition 1: A predicted path PR of vehicle VA intersects with the reference line. In other words, it is predicted that vehicle VA will deviate from the reference line.

Condition 2: The vehicle VA has deviated from the reference line.

In the deviation suppression control, the ECU 20 acquires a target steered angle θtgt for suppressing the vehicle VA from deviating from the reference line where the vehicle VA is likely to deviate (or has deviated). In other words, the target steered angle θtgt is used for returning the vehicle VA to the travel area TA. The ECU 20 controls the steering motor 32 such that the steered angle θ matches the target steered angle θtgt.

### Outline of Operation

When a suppression condition is satisfied, the ECU 20 decreases a magnitude of a lateral speed of the vehicle VA in the deviation suppression control compared to when the suppression condition is not satisfied. The suppression condition is satisfied when at least first condition is satisfied. The first condition is satisfied when there is an object (another vehicle VB shown in FIG. 2) in an opposite area opposite to a side where the vehicle VA deviates. The lateral speed of the vehicle VA is a speed in a width direction of the vehicle VA.

Therefore, the present apparatus 10 decreases a speed at which the vehicle VA approaches the object which is present in the opposite area so as to be able to reduce a possibility that a driver feels anxiety about the deviation suppression control.

### Operation

When the deviation condition is satisfied and the suppression condition is not satisfied, the ECU20 sets a normal travel route TR (referring to FIG. 2) that the vehicle VA travels along in the deviation suppression control.

First, the ECU20 determines a lateral position of “a change position CP and a target return position RP” relative to the boundary BL, based on the vehicle speed Vs, the position of the vehicle VA relative to the boundary BL, a shape of the travel area TA, a deviation lateral speed and a deviation lateral acceleration.

The change position CP is a position at which a travel direction of the vehicle VA is changed from a deviation direction (a direction towards the top of a page in FIG. 2) to a return direction (a direction towards the bottom of the page in FIG. 2). The deviation direction is a direction in which the vehicle deviates from the travel area TA. The return direction is a direction in which the vehicle VA returns to the travel area TA. In other words, the change position CP is a position at which the vehicle VA deviates the most.

The target return position RP is a position that is a predetermined distance inside the reference line.

The deviation lateral speed is the lateral speed of the vehicle VA when the deviation condition is satisfied.

The deviation lateral acceleration is a lateral acceleration of the vehicle VA when the deviation condition is satisfied.

Next, the ECU20 determines a longitudinal position of “the change position CP and the target return position RP” relative to the boundary BL, under the following constrains.

### Constrains

Constrain 1: The lateral speed is equal to or smaller than a predetermined upper limit lateral speed.

Constrain 2: The lateral acceleration is equal to or smaller than a predetermined upper limit lateral acceleration.

Constrain 3: A first time T1 which it takes for the vehicle VA to reach the change position CP from a start position SP is equal to or shorter than a first threshold time T1th. The start point SP is a position of the vehicle VA when the deviation condition is satisfied.

Constrain 4: A second time T2 which it takes for the vehicle VA to reach the target return position RP from the change position CP is equal to or shorter than a second threshold time T2th.

Next, the ECU20 sets, as the normal travel route TR, a route that passes through the change position CP and the target return position RP.

When the deviation condition is satisfied and the suppression condition is not satisfied, the ECU20 acquires the target steered angle θtgt for vehicle VA to travel along the normal travel route TR, and controls the steering motor 32 such that the steered angle θ matches the target steered angle θtgt.

On the other hand, when the deviation condition is satisfied and the suppression condition is satisfied, the ECU20 sets a suppression travel route TR′. The setting of the suppression travel route TR′ is the same as the setting of the normal travel route TR, except that the following constraint 4′ is used instead of the constraint 4.

Constraint 4′: The second time T2 is equal to or shorter than a third threshold time T3th, which is longer than the second threshold time T2th.

When the suppression condition is satisfied, the constraint 4′ which is less strict than the constraint 4 is used to set the suppression travel route TR′. For this reason, when the suppression condition is satisfied, the second time T2 is longer than when the suppression condition is not satisfied. Therefore, when the suppression condition is satisfied, “the magnitude of the lateral speed of the vehicle VA during a time (the second time T2) which it takes for the vehicle VA to travel from the change position CP to the target return position RP” is smaller than when the suppression condition is not satisfied. Since the speed at which the vehicle VA approaches the object (the other vehicle VB) decreases (slows down), the possibility that the driver feels anxiety about the deviation suppression control can be reduced.

The vehicle VA travels in a direction away from the object (the other vehicle VB) during a time (the first time T1) which it takes for the vehicle VA to travel from the start position SP to the change position CP. The lateral speed of the vehicle VA during the first time T1 does not affect the driver's anxiety. If the magnitude of the lateral speed of the vehicle VA during the first time T1 decreases (slows down), a time during which the vehicle VA is deviating from the travel area TA increases. For this reason, in the present embodiment, when the suppression condition is satisfied, the same first time T1 as when the suppression condition is satisfied is used.

Next, the suppression condition is described in detail.

The ECU20 determines that the suppression condition is satisfied when all of the above-mentioned first condition and the following second condition and third condition are satisfied.

Second condition: There is the object within a predetermined range AR of the vehicle VA when the vehicle VA reaches the target return position RP on an assumption that the suppression condition is not satisfied (in other words, on assumption that the vehicle VA travels along the normal travel route TR). The predetermined range AR is set in front of the vehicle VA.

Third condition: A magnitude of a subtraction value (|WL−WV|) is equal to or smaller than a threshold value Wth. The subtraction value is acquired by subtracting a vehicle width WV of the vehicle VA from a width WL of the travel area TA.

If the second condition is not satisfied (in other words, if there is no object within the predetermined range AR of vehicle VA when the vehicle VA reaches the target return position RP of the normal driving route TR), a possibility that the driver feels anxiety is low because the vehicle VA does not approach the object that is in the opposite area. In such case, if the magnitude of the lateral speed of vehicle VA in the deviation suppression control becomes small, a possibility that the driver feels uncomfortable is high. For this reason, the second condition is included in the suppression condition.

If the third condition is not satisfied, the width WL of the travel area TA is relatively wide compared to the vehicle width WV. For this reason, even if the vehicle VA approaches the object that is in the opposite area at the same lateral speed as when the suppression condition is not satisfied, the possibility that the driver feels anxiety is low. In such case, if the magnitude of the lateral speed of vehicle VA in the deviation suppression control becomes small, the possibility that the driver feels uncomfortable is high. For this reason, the third condition is included in the suppression condition.

### Specific Operation

### Start and End Determination Routine

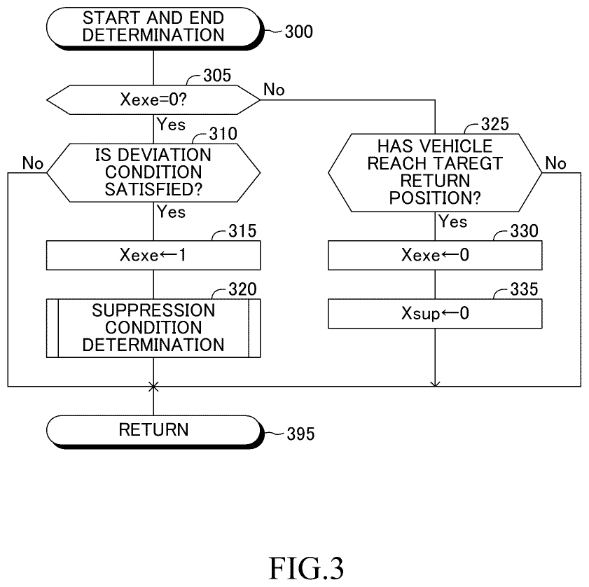

The CPU of the ECU 20 executes a routine shown by a flowchart in FIG. 3 every time a predetermined time elapses.

When an appropriate time point comes, the CPU starts a process from step 300 in FIG. 3 and the process proceeds to step 305. At step 305, the CPU determines whether or not an execution flag Xexe is “0”.

The execution flag Xexe is set to “1” when the deviation suppression control is executed, and is set to “0” when the deviation suppression control is not executed. Furthermore, the execution flag Xexe is set to “0” in an initialization routine. The initialization routine is executed by the CPU when an ignition key switch (not shown) of the vehicle VA is changed from an off position to an on position.

If the execution flag Xexe is “0”, the CPU makes a “Yes” determination at Step 305 and the process proceeds to step 310. At Step 310, the CPU determines whether or not the deviation condition is satisfied.

If the deviation condition is not satisfied, the CPU makes a “No” determination at step 310. Thereafter, the process proceeds to step 395, and the CPU terminates the present routine tentatively. On the other hand, if the deviation condition is satisfied, the CPU makes a “Yes” determination at step 310 and executes steps 315 and 320.

Step 315: The CPU sets the execution flag Xexe to “1”.

Step 320: The CPU executes a suppression condition determination subroutine. In the suppression condition determination subroutine, the CPU determines whether or not the suppression condition is satisfied. A detail of the suppression condition determination subroutine is described later.

Thereafter, the process proceeds to step 395, and the CPU terminates the present routine tentatively.

If the execution flag Xexe is “1” when the process proceeds to step 305, the CPU makes a “No” determination at step 305 and the process proceeds to step 325. At step 325, the CPU determines whether or not the vehicle VA has reached the target return position RP.

If the vehicle VA has not yet reached the target return position RP, the CPU makes a “No” determination at step 325. Thereafter, the process proceeds to step 395, and the CPU terminates the present routine tentatively. On the other hand, if the vehicle VA has reached the target return position RP, the CPU makes a “Yes” determination at step 325 and executes steps 330 and 335.

Step 330: The CPU sets the execution flag Xexe to “0”.

Step 335: The CPU sets a suppression flag Xsup to “0”.

The suppression flag Xsup is set to “1” when the suppression condition is satisfied, and is set to “0” when the suppression condition is not satisfied. Furthermore, the suppression flag Xsup is set to “0” in the initialization routine.

Thereafter, the process proceeds to step 395, and the CPU terminates the present routine tentatively.

### Suppression Condition Determination Subroutine

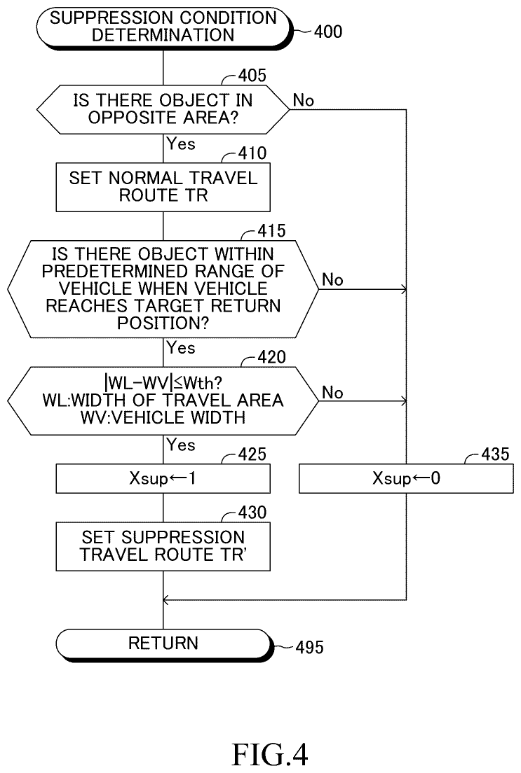

When the process proceeds to step 320 in FIG. 3, the CPU starts a process from step 400 in FIG. 4, and the process proceeds to step 405. At step 405, the CPU determines whether or not there is the object in the opposite area. In other words, the CPU determines whether or not the first condition is satisfied.

If there is the object in the opposite area, the CPU makes a “Yes” determination at step 405 and executes steps 410 and 415.

Step 410: The CPU sets the normal travel route TR.

Step 415: The CPU determines whether or not there is the object within the predetermined range AR of the vehicle VA when the vehicle reaches the target return position RP under the following assumptions 1 and 2. In other words, at step 415, the CPU determines whether or not the second condition is satisfied.

Assumption 1: The vehicle VA travels along the normal travel route TR to reach the target return position RP.

Assumption 2: The object continues to move in a movement direction estimated based on a history of the position of the object.

If there is the object within the predetermined range AR of the vehicle VA when the vehicle VA reaches the target return position RP, the CPU makes a “Yes” determination at step 415 and the process proceeds to step 420. At step 420, the CPU determines whether or not the magnitude of the above subtraction value (|WL−WV |) is equal to or smaller than the threshold value Wth (in other words, the CPU determines whether or not the third condition is satisfied).

If the magnitude of the above subtraction value (|WL−WV|) is equal to or smaller than the threshold value Wth, the CPU makes a “Yes” determination at step 420 and executes steps 425 and 430.

Step 425: The CPU sets the suppression flag Xsup to “1”.

Step 430: The CPU sets the suppression travel route TR′.

Thereafter, the process proceeds to step 495, and the CPU terminates the present routine tentatively. Thereafter, the process proceeds to step 395 in FIG. 3.

If there is no object in the opposite area when the process proceeds to step 405, the CPU makes a “No” determination at step 405 and the process proceeds to step 435. At step 435, the CPU sets the suppression flag Xsup to “0”. Thereafter, the process proceeds to step 495 and the CPU terminates the present routine tentatively.

If there is the object within the predetermined range AR of the vehicle VA when the vehicle VA reaches the target return position RP, when the process proceeds to step 415, the CPU makes a “No” determination at step 415, and the process proceeds to step 435.

If the magnitude of the above subtraction value (|WL−WV|) is greater than the threshold value Wth when the process proceeds to step 420, the CPU makes a “No” determination at Step 420 and the process proceeds to step 435.

### Deviation Suppression Control Routine

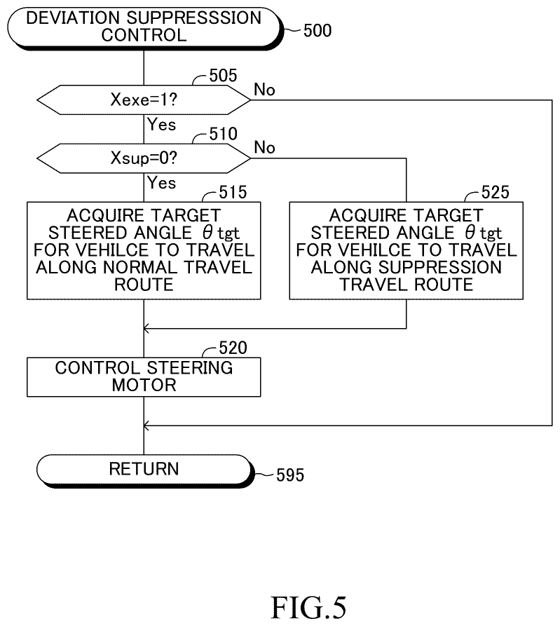

The CPU of the ECU 20 executes a routine shown by a flowchart in FIG. 5 every time a predetermined time elapses.

When an appropriate time point comes, the CPU starts a process from step 500 in FIG. 5 and the process proceeds to step 505. At step 505, the CPU determines whether or not the execution flag Xexe is “0”.

If the execution flag Xexe is “0”, the CPU makes a “No” determination at step 505. Thereafter, the process proceeds to step 595, and the CPU terminates the present routine tentatively. If the execution flag Xexe is “1”, the CPU makes a “Yes” determination at step 505 and the process proceeds to step 510. At step 510, the CPU determines whether or not the suppression flag Xsup is “0”.

If the suppression flag Xsup is “0”, the CPU makes a “Yes” determination at step 510 and executes steps 515 and 520.

Step 515: The CPU acquires the target steered angle θtgt for the vehicle VA to travel along the normal travel route TR.

Step 520: The CPU controls the steering motor 32 such that the steered angle θ matches the target steered angle θtgt.

Thereafter, the process proceeds to step 595, and the CPU terminates the present routine tentatively.

If the suppression flag Xsup is “1”, the CPU makes a “No” determination at step 510 and the process proceeds to step 525. At step 525, the CPU acquires the target steered angle θtgt for the vehicle VA to travel along the suppression travel route TR′. Thereafter, the process proceeds to step 520.

As a result of the above, when the suppression condition is satisfied, the magnitude of the lateral speed of the vehicle VA in the deviation suppression control is smaller (decreases) than (compared to) when the suppression condition is not satisfied. The speed at which the vehicle VA approaches the object in the opposite area decreases. Accordingly, the possibility that the driver feels anxiety about the deviation suppression control can be reduced.

The present disclosure should not be limited to the above-described embodiment, and may employ various modifications within the scope of the present disclosure.

### First Modification

If the suppression condition is satisfied, the ECU 20 of the deviation suppression control device 10 according to the present modification increases/lengthens the second time T2 (in other words, the ECU 20 decreases the magnitude of the lateral speed of the vehicle VA), as an object distance WB (see FIG. 2) decreases. The object distance WB is a distance between the object satisfies the first condition of the suppression condition and an opposite boundary BL. The opposite boundary BL is the boundary BL on the opposite side to the boundary BL on the side where the vehicle VA deviates.

The shorter the object distance WB, the shorter a time for the vehicle VA to approach the object. This increases the driver's anxiety. According to the present modification, the shorter the object distance WB, the smaller the magnitude of the lateral speed of vehicle VA. Therefore, the possibility that the driver feels anxiety about the deviation suppression control can be reduced.

### Second Modification

The ECU 20 of the deviation suppression control apparatus 10 according to the present modification uses the following fourth condition instead of the third condition of the suppression condition.

Fourth condition: A ratio RT of the vehicle width WV to the width WL of the travel area TA is equal to or greater than a threshold value Rth.

If the fourth condition is not satisfied, the width WL is relatively wide compared to the vehicle width WV, and if the fourth condition is satisfied, the width WL is relatively narrow compared to the vehicle width WV. For this reason, the fourth condition is used instead of the third condition.

### Third Modification

In the above embodiment, it is determined whether or not the suppression condition is satisfied at a satisfaction time at which the deviation condition is satisfied, but a timing of determining of the suppression condition is not limited to this. If the suppression condition is not satisfied at the satisfaction time, the ECU 20 of the deviation suppression control apparatus 10 according to the present modification continues to determine whether or not the suppression condition is satisfied after the satisfaction time.

### Fourth Modification

When the suppression condition is satisfied, the ECU 20 according to the above embodiment increases the second time T2 compared to when the suppression condition is not satisfied, and does not change the first time T1 regardless of the suppression condition. When the suppression condition is satisfied, the ECU 20 of the deviation suppression control apparatus 10 according to the present modification may increase the first time T1 in addition to the second time T2.

Furthermore, when the suppression condition is satisfied, the ECU 20 does not increase the second time T2 compared to when the suppression condition is not satisfied, but may decrease a magnitude of the upper limit lateral speed compared to than when the suppression condition is not satisfied.

The present apparatus 10 may be applied to (or installed in/on) an engine vehicle, a hybrid electric vehicle (HEV), a plug-in hybrid electric vehicle (PHEV), a fuel cell electric vehicle (FCEV), and a battery electric vehicle (BEV). The present apparatus 10 may be applied to (or installed in/on) an automatic driving vehicle. The present disclosure may include a non-transitory computer-readable storage medium storing a program for realizing the functions of the present apparatus 10.

What is claimed is:

1. A deviation suppression control apparatus configured to execute a deviation suppression control for controlling a lateral travel state of a vehicle to suppress the vehicle from deviating from a travel area when a deviation condition is satisfied, the deviation condition being a condition that is satisfied when the vehicle is predicted to deviate from the travel area or when the vehicle has deviated from the travel area,
wherein,
the deviation suppression control apparatus is configured to, when a suppression condition including a first condition is satisfied, decrease a magnitude of a lateral speed of the vehicle in the deviation suppression control compared to when the suppression condition is not satisfied, the first condition being a condition that is satisfied when there is an object in an opposite area opposite to a deviation side where the vehicle deviates from the travel area.

2. The deviation suppression control apparatus according to claim 1,
wherein,
the deviation suppression control apparatus is configured to:
end the deviation suppression control when the vehicle reaches a target return position set inside a boundary that defines the travel area; and
determine that the suppression condition is satisfied when the first condition and a second condition are satisfied, the second condition being a condition that is satisfied in a case where it is predicted that there is the object within a predetermined range of the vehicle when the vehicle reaches the target return position on an assumption that the suppression condition is not satisfied.

3. The deviation suppression control apparatus according to claim 1,
wherein,
the deviation suppression control apparatus is configured to, when the suppression condition is satisfied, decrease the magnitude of the lateral speed during a time that it takes for the vehicle to reach a target return position set inside a boundary that defines the travel area from a change position, the change position being a position at which a travel direction of the vehicle is changed from a deviation direction in which the vehicle deviates from the travel area to a return direction in which the vehicle returns to the travel area in the deviation suppression control.

4. The deviation suppression control apparatus according to claim 1,
wherein,
the deviation suppression control apparatus is configured to determine that the suppression condition is satisfied when the first condition is satisfied and a third condition or a fourth condition is satisfied,
wherein,
the third condition is satisfied when a subtraction value acquired by subtracting a vehicle width of the vehicle from a width of the travel area is equal to or smaller than a predetermined first threshold value,
the fourth condition is satisfied when a ratio of the vehicle width to the width of the travel area is equal to or greater than a predetermined second threshold value.

5. The deviation suppression control apparatus according to claim 1,
wherein,
the deviation suppression control apparatus is configured to decrease the magnitude of the lateral speed, as an object distance decreases, the object distance being a distance between the object and an opposite boundary on an opposite side of a boundary from which the vehicle deviates of a left boundary and a right boundary that define the travel area.

6. A deviation suppression control method executed by a computer installed on a vehicle to execute a deviation suppression control for controlling a lateral travel state of the vehicle to suppress the vehicle from deviating from a travel area when a deviation condition is satisfied, the deviation condition being a condition that is satisfied when the vehicle is predicted to deviate from the travel area or when the vehicle has deviated from the travel area, comprising:
a first step of determining whether or not a suppression condition including a first condition is satisfied, the first condition being a condition that is satisfied when there is an object in an opposite area opposite to a deviation side where the vehicle deviates from the travel area; and
a second step of decreasing a magnitude of a lateral speed of the vehicle in the deviation suppression control compared to when the suppression condition is not satisfied, when the suppression condition is satisfied.

7. A non-transitory computer-readable storage medium storing a program for causing a computer installed on a vehicle to execute a deviation suppression control for controlling a lateral travel state of the vehicle to suppress the vehicle from deviating from a travel area when a deviation condition is satisfied, the deviation condition being a condition that is satisfied when the vehicle is predicted to deviate from the travel area or when the vehicle has deviated from the travel area, the program causing the computer to implement processes of:
determining whether or not a suppression condition including a first condition is satisfied, the first condition being a condition that is satisfied when there is an object in an opposite area opposite to a deviation side where the vehicle deviates from the travel area; and
decreasing a magnitude of a lateral speed of the vehicle in the deviation suppression control compared to when the suppression condition is not satisfied, when the suppression condition is satisfied.
